(19) United States
(12) Patent Application Publication
(10) Pub. No.: US 2026/0195215 A1
(43) Pub. Date: Jul. 9, 2026

(54) MEMORY MANAGEMENT METHOD, MEMORY STORAGE DEVICE AND MEMORY CONTROL CIRCUIT UNIT

(71) Applicant: PHISON ELECTRONICS CORP., Miaoli (TW)

(72) Inventors: Shih-Jia Zeng, Hsinchu City (TW); Chia Ming Liu, New Taipei City (TW); Chia-Hao Hsu, Taipei City (TW); Luong Khon, Miaoli County (TW); Li Lin, Hsinchu City (TW)

(73) Assignee: PHISON ELECTRONICS CORP., Miaoli (TW)

(21) Appl. No.: 19/052,307

(22) Filed: Feb. 13, 2025

(30) Foreign Application Priority Data
Jan. 3, 2025 (TW) 114100202

(51) Int. Cl. G06F 11/10; G06F 11/07

(52) U.S. Cl. CPC G06F 11/1016; G06F 11/0757; G06F 11/1068

(57) ABSTRACT

A memory management method, a memory storage device, and a memory control circuit unit are provided. The method includes: setting a timer corresponding to a first physical unit after powering on; performing a read operation on the first physical unit and determining whether a data error condition is met; and marking the first physical unit as a bad physical unit when the data error condition is met and an elapsed time indicated by the timer is less than a threshold time.

### CROSS-REFERENCE TO RELATED APPLICATION

This application claims the priority benefit of Taiwan application serial no. 114100202, filed on Jan. 3, 2025. The entirety of the above-mentioned patent application is hereby incorporated by reference herein and made a part of this specification.

### BACKGROUND

### Technical Field

The disclosure relates to a memory management method, a memory storage device, and a memory control circuit unit for marking a bad physical unit.

### Description of Related Art

Portable electronic devices such as mobile phones and notebook computers have grown rapidly in recent years, resulting in a rapid increase in consumer demand for storage media. Since the rewritable non-volatile memory module (for example a flash memory) has characteristics such as non-volatile data, power saving, small size, and no mechanical structure, the rewritable non-volatile memory module is very suitable to be built in the various portable electronic devices.

In the long-term use of the rewritable non-volatile memory module, the reliability of data stored in blocks will gradually decrease. Especially when the number of erasures of certain blocks increases, the data in these blocks will be easily disturbed, resulting in an increase in the number of error bits. When the number of error bits in a block exceeds the fault tolerance, the block will be marked as a bad block and stopped being used. Apart from bad blocks arising due to deterioration of service life, during the manufacturing process, due to process variations or other production issues, some blocks may have potential defects since leaving the factory, making them prone to errors under normal use. Early marking and management of these defective blocks is critical to the reliability of the rewritable non-volatile memory module.

### SUMMARY

The disclosure proposes a memory management method, a memory storage device, and a memory control circuit unit that may mark physical units that are defective during production, and may also avoid erroneously marking physical units due to endurance failure.

The disclosure proposes a memory management method for a rewritable non-volatile memory module. The rewritable non-volatile memory module includes a plurality of physical units. The memory management method includes: setting a timer corresponding to a first physical unit after powering on; performing a read operation on the first physical unit and determining whether a data error condition is met; and marking the first physical unit as a bad physical unit when the data error condition is met and an elapsed time indicated by the timer is less than a threshold time.

In an embodiment of the disclosure, the above memory management method further includes: resetting the timer when powering on.

In an embodiment of the disclosure, the above memory management method further includes: resetting the timer when the first physical unit is programmed.

In an embodiment of the disclosure, the above read operation includes a hard decoding process, and the hard decoding process is used to detect a plurality of error bits in the first physical unit. The above steps of determining whether the data error condition is met include: when the number of error bits is greater than a threshold number, increasing the number of errors; and when the number of errors is greater than the threshold number of times, determining that the data error condition is met.

In an embodiment of the disclosure, the above step of determining whether the data error condition is met includes: when the hard decoding process fails, performing the soft decoding process and increasing the number of errors; and when the number of errors is greater than the threshold number of times, determining that the data error condition is met.

In an embodiment of the disclosure, the above threshold number of times is greater than or equal to 2. The memory management method also includes resetting the number of errors when powering on.

In an embodiment of the disclosure, the memory management method includes: when the hard decoding process fails, performing the soft decoding process; and when the soft decoding process fails, performing a cross-frame decoding. The above step to determine whether the data error condition is met is based on non-RAID ECC parity information.

From another perspective, embodiments of the disclosure provide a memory storage device, including: a connection interface unit, configured to be coupled to a host system; a rewritable non-volatile memory module, including a plurality of physical units; and a memory control circuit unit, coupled to the connection interface unit and the rewritable non-volatile memory module. The memory control circuit unit is configured to perform a plurality of steps: setting a timer corresponding to a first physical unit after powering on; performing a read operation on the first physical unit and determining whether a data error condition is met; and marking the first physical unit as a bad physical unit when the data error condition is met and an elapsed time indicated by the timer is less than a threshold time.

From another perspective, embodiments of the disclosure provide a memory control circuit unit for controlling a rewritable non-volatile memory module. The memory control circuit unit includes: a host interface, configured to be coupled to a host system; a memory interface, configured to be coupled to the rewritable non-volatile memory module; a memory management circuit, configured to be coupled to the host interface and the memory interface. The memory management circuit is configured to perform a plurality of steps: setting a timer corresponding to a first physical unit after powering on; performing a read operation on the first physical unit and determining whether a data error condition is met; and marking the first physical unit as a bad physical unit when the data error condition is met and an elapsed time indicated by the timer is less than a threshold time.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a flowchart of a memory management method according to an embodiment.

FIG. 8 is a schematic diagram of an operation of a timer according to a scenario.

FIG. 9 is a schematic diagram of an operation of a timer according to another scenario.

FIG. 10 is a flowchart of a memory management method according to an embodiment.

FIG. 11 is a flowchart of a memory management method according to another embodiment.

### DESCRIPTION OF THE EMBODIMENTS

Some embodiments of the disclosure will be described in detail with reference to the accompanying drawings. For reference numerals cited in the following descriptions, the same reference numerals appearing in different drawings are regarded as the same or similar elements. The embodiments are only a part of the disclosure and do not disclose all possible implementations of the disclosure. More precisely, the embodiments are merely examples of the system and the method within the scope of the disclosure.

Moreover, terms such as “first” and “second” used herein do not represent order, and it should be understood that they are for differentiating devices or operations having the same technical terms.

Generally speaking, a memory storage device (also known as a memory storage system) includes a rewritable non-volatile memory module and a controller (also known as a control circuit). The memory storage device may be used with a host system such that the host system may write data to the memory storage device or read data from the memory storage device.

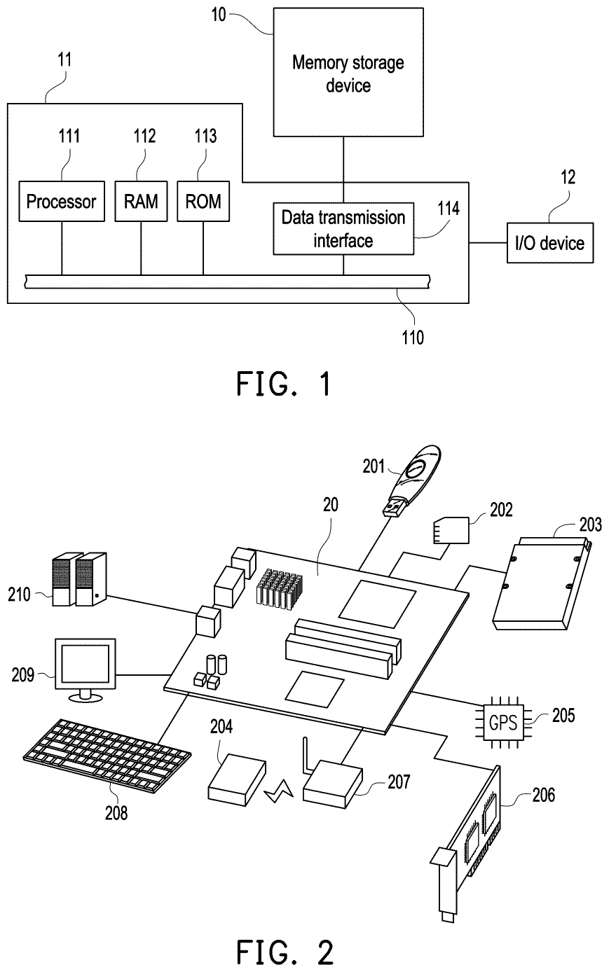

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Referring to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transmission interface 114. For example, the host system 11 may store data to or read data from the memory storage device 10 through the data transmission interface 114. In addition, the host system 11 may be coupled to an I/O device 12 through the system bus 110. For example, the host system 11 may transmit output signals to the I/O device 12 or receive input signals from the I/O device 12 through the system bus 110.

In an exemplary embodiment, the processor 111, the random access memory 112, the read only memory 113, and the data transmission interface 114 may be disposed on a motherboard 20 of the host system 11. The number of data transmission interfaces 114 may be one or more. Through the data transmission interface 114, the motherboard 20 may be coupled to the memory storage device 10 through a wired or wireless manner.

In an exemplary embodiment, the memory storage device 10 may be, for example, a flash drive 201, a memory card 202, a solid state drive (SSD) 203, or a wireless memory storage device 204. The wireless memory storage device 204 may be, for example, a near field communication (NFC) memory storage device, a WiFi memory storage device, a Bluetooth memory storage device, a low-power Bluetooth memory storage device (for example, iBeacon), or other memory storage devices based on various wireless communication technologies. In addition, the motherboard 20 may also be coupled to a global positioning system (GPS) module 205, a network interface card 206, a wireless transmission device 207, a keyboard 208, a screen 209, a speaker 210, or various I/O devices through the system bus 110. For example, in an exemplary embodiment, the motherboard 20 may access the wireless memory storage device 204 through the wireless transmission device 207.

In an exemplary embodiment, the host system 11 is a computer system. In an exemplary embodiment, host system 11 may be any system that may substantially cooperate with a memory storage device to store data. In an exemplary embodiment, the memory storage device 10 and the host system 11 may respectively include a memory storage device 30 and a host system 31 of FIG. 3.

FIG. 3 is a schematic diagram of a host system and a memory storage device according to an exemplary embodiment of the disclosure. Referring to FIG. 3, the memory storage device 30 may be used in conjunction with the host system 31 to store data. For example, the host system 31 may be a digital camera, a video camera, a communication device, an audio player, a video player, a tablet computer, or other systems. For example, the memory storage device 30 may be a secure digital (SD) card 32, a compact flash (CF) card 33, an embedded storage device 34, or various other non-volatile memory storage devices used by the host system 31. The embedded storage device 34 includes an embedded multi media card (eMMC) 34, an embedded multi chip package (eMCP) storage device 342, and/or various other embedded storage devices in which a memory module is directly coupled onto a substrate of a host system.

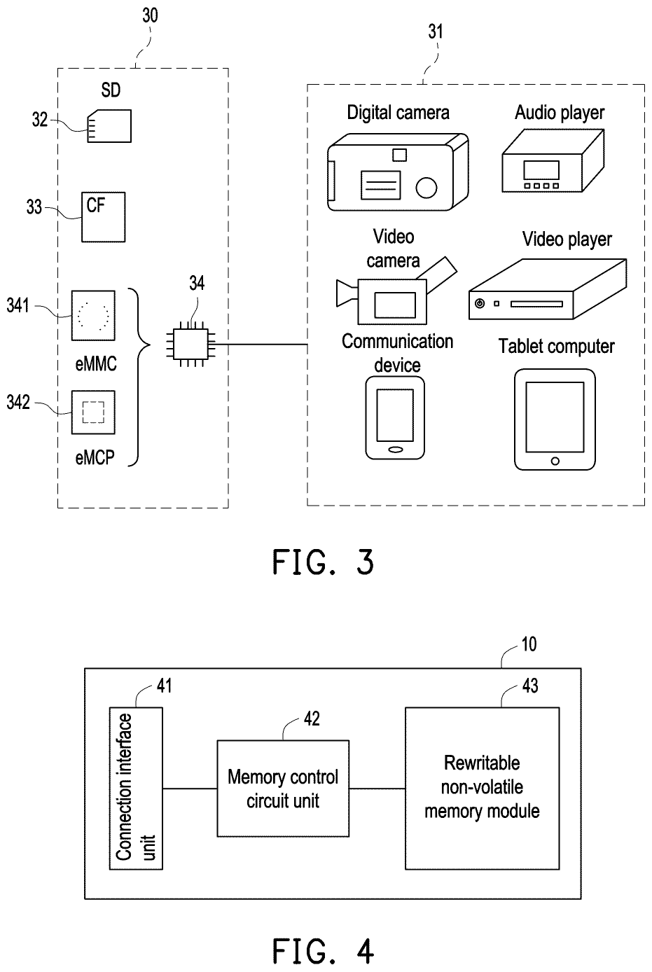

FIG. 4 is a schematic diagram of a memory storage device according to an exemplary embodiment of the disclosure. Referring to FIG. 4, the memory storage device 10 includes a connection interface unit 41, a memory control circuit unit 42, and a rewritable non-volatile memory module 43.

The connection interface unit 41 is configured to be coupled to the host system 11. The memory storage device 10 may communicate with the host system 11 through the connection interface unit 41. In an exemplary embodiment, the connection interface unit 41 is compatible with the peripheral component interconnect express (PCI express) standard. In an exemplary embodiment, the connection interface unit 41 may also comply with the serial advanced technology attachment (SATA) standard, the parallel advanced technology attachment (PATA) standard, the Institute of Electrical and Electronic Engineers (IEEE) 1394 Standard, the universal serial bus (USB) standard, the SD interface standard, the ultra high speed-I (UHS-I) interface standard, the ultra high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 41 and the memory control circuit unit 42 may be packaged in a chip, or the connection interface unit 41 may be arranged outside a chip containing the memory control circuit unit 42.

The memory control circuit unit 42 is coupled to the connection interface unit 41 and the rewritable non-volatile memory module 43. The memory control circuit unit 42 is used to perform a plurality of logic gates or control commands implemented in the form of hardware or the form of firmware and perform operations such as data writing, reading, and erasing in the rewritable non-volatile memory module 43 according to a command of the host system 11.

The rewritable non-volatile memory module 43 is used to store data written by the host system 11. The rewritable non-volatile memory module 43 may include a single level cell (SLC) NAND flash memory module (that is, a flash memory module that may store 1 bit in a memory cell), a multi level cell (MLC) NAND flash memory module (that is, a flash memory module that may store 2 bits in a memory cell), a triple level cell (TLC) NAND flash memory module (that is, a flash memory module that may store 3 bits in a memory cell), a quad level cell (QLC) NAND flash memory module (that is, a flash memory module that may store 4 bits in a memory cell), other flash memory modules, or other memory modules with the same characteristics.

Each memory cell in the rewritable non-volatile memory module 43 stores one or more bits with changes in voltage (hereinafter also referred to as threshold voltage). Specifically, there is a charge trapping layer between a control gate and a channel of each memory cell. By applying a write voltage to the control gate, the number of electrons in the charge trapping layer may be changed, thereby changing the threshold voltage of the memory cell. The operation of changing the threshold voltage of the memory cell is also referred to as “writing data to the memory cell” or “programming the memory cell.” As the threshold voltage changes, each memory cell in the rewritable non-volatile memory module 43 has a plurality of storage states. By applying a read voltage, it is possible to determine which storage state a memory cell belongs to, thereby obtaining one or more bits stored to the memory cell.

In an exemplary embodiment, the memory cells of the rewritable non-volatile memory module 43 may constitute a plurality of physical programming units, and the physical programming units may constitute a plurality of physical erasing units. Specifically, the memory cells on the same word line may form one or more physical programming units. If each memory cell may store more than 2 bits, the physical programming units on the same word line may be at least classified into a lower physical programming unit and an upper physical programming unit. For example, a least significant bit (LSB) of a memory cell belongs to the lower physical programming unit, and a most significant bit (MSB) of a memory cell belongs to the upper physical programming unit. Generally speaking, in MLC NAND flash memory, the write speed of the lower physical programming unit is greater than the write speed of the upper physical programming unit, and/or the reliability of the lower physical programming unit is higher than the reliability of the upper physical programming unit.

In an exemplary embodiment, the physical programming unit is the smallest unit of programming. That is, the physical programming unit is the smallest unit for writing data. For example, the physical programming unit may be a physical page or a physical sector. If the physical programming unit is a physical page, the physical programming unit may include a data bit area and a redundancy bit area. The data bit area contains a plurality of physical sectors for storing user data, and the redundant bit area is used to store system data (for example, management data such as an error correcting code). In an exemplary embodiment, the data bit area contains 32 physical sectors, and the size of one physical sector is 512 bytes (B). However, in other exemplary embodiments, the data bit area may also contain 8, 16, or more or less physical sectors, and the size of each physical sector may also be larger or smaller. On the other hand, the physical erasing unit is the smallest unit of erasure. That is, each physical erasing unit contains the smallest number of memory cells to be erased together. For example, the physical erasing unit is a physical block.

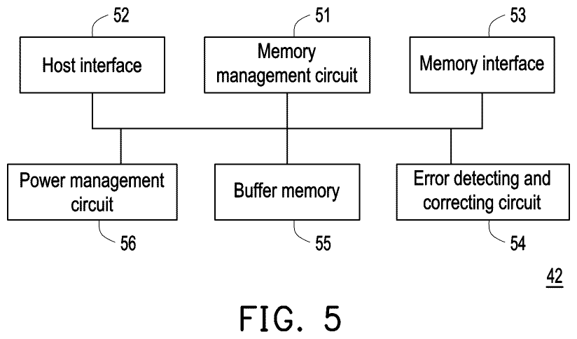

FIG. 5 is a schematic diagram of a memory control circuit unit according to an exemplary embodiment of the disclosure. Referring to FIG. 5, the memory control circuit unit 42 includes a memory management circuit 51, a host interface 52, and a memory interface 53.

The memory management circuit 51 is used to control the entire operation of the memory control circuit unit 42. Specifically, the memory management circuit 51 has a plurality of control commands, and when the memory storage device 10 is operating, the control commands are executed to perform operations such as data writing, reading, and erasing. The following description of the operation of the memory management circuit 51 is equivalent to the description of the operation of the memory control circuit unit 42 and the memory storage device 10.

In an exemplary embodiment, the control commands of the memory management circuit 51 are implemented in the form of firmware. For example, the memory management circuit 51 has a microprocessor unit (not shown) and a read only memory (not shown), and the control commands are burnt into the read only memory. When the memory storage device 10 is operating, the control commands are executed by the microprocessor unit to perform operations such as data writing, reading, and erasing.

In an exemplary embodiment, the control commands of the memory management circuit 51 may also be stored to a specific area (for example, a system area dedicated to storing system data in the memory module) of the rewritable non-volatile memory module 43 in the form of program codes. In addition, the memory management circuit 51 has a microprocessor unit (not shown), a read only memory (not shown), and a random access memory (not shown). in particular, the read only memory has a boot code, and when the memory control circuit unit 42 is enabled, the microprocessor unit first executes the boot code to load the control commands stored in the rewritable non-volatile memory module 43 into the random access memory of the memory management circuit 51. Afterwards, the microprocessor unit runs the control commands to perform operations such as data writing, reading, and erasing.

In an exemplary embodiment, the control commands of the memory management circuit 51 may also be implemented in the form of hardware. For example, the memory management circuit 51 includes a microcontroller, a memory cell management circuit, a memory write circuit, a memory read circuit, a memory erase circuit, and a data processing circuit. The memory cell management circuit, the memory write circuit, the memory read circuit, the memory erase circuit, and the data processing circuit are coupled to the microcontroller. The memory cell management circuit is used to manage a memory cell or a memory cell group of the rewritable non-volatile memory module 43. The memory write circuit is used to issue a write command sequence to the rewritable non-volatile memory module 43 to write data to the rewritable non-volatile memory module 43. The memory read circuit is used to issue a read command sequence to the rewritable non-volatile memory module 43 to read data from the rewritable non-volatile memory module 43. The memory erase circuit is used to issue an erase command sequence to the rewritable non-volatile memory module 43 to erase data from the rewritable non-volatile memory module 43. The data processing circuit is used to process data to be written to the rewritable non-volatile memory module 43 and data read from the rewritable non-volatile memory module 43. The write command sequence, the read command sequence, and the erase command sequence may each include one or more program codes or command codes and are used to instruct the rewritable non-volatile memory module 43 to perform corresponding operations such as writing, reading, and erasing. In an exemplary embodiment, the memory management circuit 51 may also issue other types of command sequences to the rewritable non-volatile memory module 43 to instruct to perform corresponding operations.

The host interface 52 is coupled to the memory management circuit 51. The memory management circuit 51 may communicate with the host system 11 through the host interface 52. The host interface 52 may be used to receive and identify commands and data sent by the host system 11. For example, commands and data sent by the host system 11 may be sent to the memory management circuit 51 through the host interface 52. In addition, the memory management circuit 51 may send the data to the host system 11 through the host interface 52. In this exemplary embodiment, the host interface 52 is compatible with the PCI Express standard. However, it must be understood that the disclosure is not limited thereto; the host interface 52 may also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transmission standards.

The memory interface 53 is coupled to the memory management circuit 51 and is used to access the rewritable non-volatile memory module 43. For example, the memory management circuit 51 may access the rewritable non-volatile memory module 43 through the memory interface 53. That is to say, the data to be written to the rewritable non-volatile memory module 43 is converted into a format acceptable by the rewritable non-volatile memory module 43 through the memory interface 53. Specifically, if the memory management circuit 51 intends to access the rewritable non-volatile memory module 43, the memory interface 53 will send a corresponding command sequence. For example, the command sequences may include the write command sequence instructing to write data, the read command sequence instructing to read data, the erase command sequence instructing to erase data, and corresponding command sequences instructing various memory operations (for example, changing a read voltage level, performing a garbage collection (GC) operation, etc.). The command sequences are generated, for example, by the memory management circuit 51 and sent to the rewritable non-volatile memory module 43 through the memory interface 53. The command sequences may include one or more signals, or data on a bus. These signals or the data may include command codes or program codes. For example, the read command sequence includes information such as a read recognition code and a memory address.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is used to perform error detecting and correcting operations to ensure the correctness of the data. Specifically, when the memory management circuit 51 receives a write command from the host system 11, the error detecting and correcting circuit 54 generates a corresponding error correcting code (ECC) and/or error detecting code (EDC) for the data corresponding to the write command, and the memory management circuit 51 writes the data corresponding to the write command and the corresponding error correcting code and/or error detecting code to the rewritable non-volatile memory module 43. Later, when the memory management circuit 51 reads the data from the rewritable non-volatile memory module 43, the error correcting code and/or error detecting code corresponding to the data will also be read, and the error detecting and correcting circuit 54 will perform error detecting and correcting operations on the read data according to the error correcting code and/or the error detecting code. For example, the error detecting and correcting circuit 54 may use a low density parity check code (LDPC code), a BCH code, a Reed-solomon code (RS code), an Exclusive OR (XOR) ) code, and other encoding/decoding algorithms to encode and decode data.

The basic unit for encoding/decoding performed by the error detecting and correcting circuit 54 is a frame (also referred to as a data frame). A frame may include a plurality of data bits. In an exemplary embodiment, a frame includes 256 bits. However, in another exemplary embodiment, a frame may also include more (for example, 4K bytes) or less bits. The error detecting and correcting circuit 54 may perform single-frame encoding and decoding on data in a single frame, and the error detecting and correcting circuit 54 may also perform cross-frame encoding and decoding on data in a plurality of frames. When performing cross-frame encoding and decoding, one or more data bits are received from each frame, and encoding and decoding are performed after receiving the data bits of a plurality of frames.

The buffer memory 55 is coupled to the memory management circuit 51 and is used to temporarily store data. The power management circuit 56 is coupled to the memory management circuit 51 and is used to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

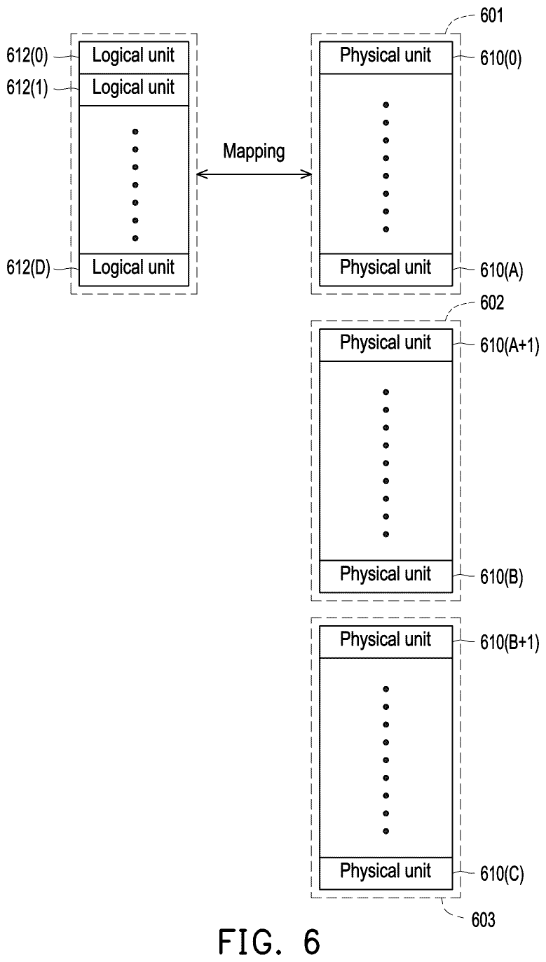

FIG. 6 is a schematic diagram of managing a rewritable non-volatile memory module according to an exemplary embodiment of the disclosure. Referring to FIG. 6, the memory management circuit 51 may logically group physical units 610(0) to 610(C) in the rewritable non-volatile memory module 43 into a storage area 601, a spare area 602, and a system area 603.

In an exemplary embodiment, a physical unit refers to a physical address or a physical programming unit. In an exemplary embodiment, a physical unit may also be composed of a plurality of continuous or discontinuous physical addresses. In an exemplary embodiment, a physical unit may also refer to a virtual block (VB). A virtual block may include a plurality of physical addresses or a plurality of physical programming units. In an exemplary embodiment, a virtual block may include one or more physical erase units.

In an exemplary embodiment, the physical units 610(0) to 610(A) in the storage area 601 are used to store user data (for example, the user data from the host system 11 of FIG. 1). For example, the physical units 610(0) to 610(A) in the storage area 601 may store valid data and invalid data. The physical units 610(A+1) to 610(B) in the spare area 602 do not store data (for example, valid data). For example, if a certain physical unit does not store valid data, the physical unit may be associated (or added) to the spare area 602. In addition, the physical units (or the physical units that do not store valid data) in the spare area 602 may be erased. When writing new data, one or more physical units may be extracted from the spare area 602 to store the new data. In an exemplary embodiment, the spare area 602 is also referred to as a free pool.

In an exemplary embodiment, the memory management circuit 51 may configure the logical units 612(0) to 612(D) to map the physical units 610(0) to 610(A) in the storage area 601. In an exemplary embodiment, each logical unit corresponds to a logical address. For example, a logical address may include one or more logical block addresses (LBA) or other logical management units. In an exemplary embodiment, a logical unit may also correspond to a logical programming unit or be composed of a plurality of continuous or discontinuous logical addresses.

It should be noted that one logical unit can be mapped to one or more physical units. If a certain physical unit is currently mapped by a certain logical unit, it means that the data currently stored in this physical unit includes valid data. On the contrary, if a certain physical unit is not currently mapped by any logical unit, it means that the data currently stored in this physical unit is invalid data.

In an exemplary embodiment, the memory management circuit 51 may record management data (also referred to as logical-to-physical mapping information) describing a mapping relationship between the logical unit and the physical unit in at least one logical-to-physical mapping table (L2P table). When the host system 11 intends to read data from the memory storage device 10 or write data to the memory storage device 10, the memory management circuit 51 may access the rewritable non-volatile memory module 43 according to the information in the logical-to-physical mapping table.

In an exemplary embodiment, the memory management circuit 51 may store specific types of data in the system area 603. For example, the physical units 610(B+1) to 610(C) in the system area 603 may be dedicated to storing data of higher importance and/or data that is not intended to be accessed or modified by the host system 11. For example, the data of higher importance and/or data not intended to be accessed or modified by the host system 11 may include a logical-to-physical mapping table, a bad block management table, a wear-leveling management table, a valid data management table, and/or other types of management data, and the disclosure is not limited thereto. The logical-to-physical mapping table is used to record mapping information. The mapping information may reflect the mapping relationship between the logical unit and the physical unit. The bad block management table is used to record information related to at least one bad block in the rewritable non-volatile memory module 43. The wear-leveling management table may be used to record information (for example, read count, write count, and/or erase count) related to the wear status of at least one physical unit in the rewritable non-volatile memory module 43. The valid data management table may be used to record information related to the valid count of at least one physical unit in the rewritable non-volatile memory module 43.

In an exemplary embodiment, the memory management circuit 51 may not map any logical unit to the physical unit in the system area 603. Thereby, the data stored in the system area 603 may be prevented from being accessed or modified by the host system 11.

Due to process variations or other factors, some physical units are defective during production, which makes the data stored in them prone to errors. For example, QLC NAND flash memory modules are more likely to have such physical units than TLC flash memory modules. If a physical unit develops a serious data error shortly after being programmed, it is likely that the physical unit was defective during production and should be marked as a bad physical unit. In contrast, if a serious data error occurs after a long time (for example, a year) after being programmed, it may be due to an endurance failure. Such a failure may be solved by reflashing the data in the physical unit. Generally speaking, if many error bits are found when reading a physical unit (which may be corrected through error correcting codes), the physical unit will be reflashed first. However, such an approach will lead to frequent reflashes when producing physical units with errors, which will reduce the performance of the entire memory storage device 10 or even make it unusable. Therefore, a method is proposed below to mark these bad physical units early.

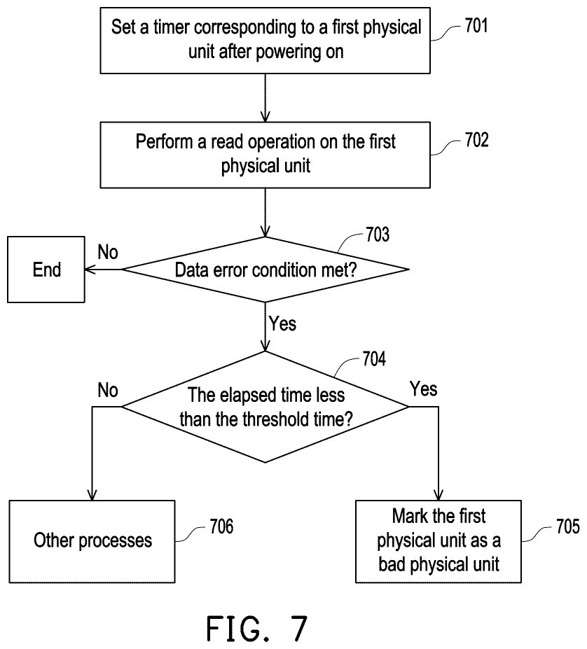

FIG. 7 is a flowchart of a memory management method according to an embodiment. Each step in FIG. 7 is performed by the memory management circuit 51 and will not be described in detail below. Referring to FIG. 7, in step 701, a timer corresponding to a first physical unit is set after powering on. In the embodiment, each physical unit has a corresponding timer. Here, the first physical unit is taken as an example. The first physical unit is, for example, a physical unit in the storage area 601 or the system area 603. For example, the timer contains a timestamp, and the memory management circuit 51 manages a clock. By subtracting the current clock and the timestamp, an elapsed time may be calculated. In other embodiments, the timer includes a counter value, and the memory management circuit 51 accumulates the counter value at intervals, so that the counter value may be used to represent how much time has passed.

In step 702, a read operation is performed on the first physical unit. In some embodiments, the read operation may include a hard decoding process. In the hard decoding process, a read voltage is set, and a read bit may be received according to whether the corresponding memory cell is turned on under the read voltage. Next, a decoding process for an error correcting code is implemented on the read bits to correct the error bits. If the number of error bits exceeds the correction capability of the error correcting code, it means that the hard decoding process has failed. In some embodiments, the read operation may also include a soft decoding process. In the soft decoding process, a plurality of read voltages are set, and a probability value may be calculated according to whether the corresponding memory cell is turned on under the read voltages. Next, a decoding process for an error correcting code (for example, LDPC) on the probability values may obtain the final read bits. If the read bits fail to pass the detection of the error correcting code, it means that the soft decoding process has failed. In some embodiments, the read operation includes a hard decoding process and a soft decoding process. When the hard decoding process fails, the soft decoding process is performed.

In step 703, it is determined whether the data error condition is met. The data error condition may take many forms. In one aspect, the data error condition is met if the above hard decoding process fails. In another aspect, the data error condition is met if the number of error bits during the hard decoding process is greater than a threshold number. In another aspect, the data error condition is met if the above soft decoding process fails. In some embodiments, when the above situation occurs, the number of errors may be accumulated. When the number of errors is greater than a threshold number of times, it is determined that the data error condition is met. In other words, when the data error condition is met, it means that a serious data error has occurred in the first physical unit. If the result of step 703 is yes, the process proceeds to step 704; otherwise, the process ends.

In step 704, it is determined whether the elapsed time indicated by the timer corresponding to the first physical unit is less than a threshold time (for example, 5 minutes). If the result of step 704 is yes, the first physical unit is marked as a bad physical unit in step 705, and the bad physical unit is no longer used. If the result of step 704 is no, other processes are performed in step 706, such as reflashing the first physical unit or not performing any processing on the first physical unit. In step 706, the first physical unit is not marked as a bad physical unit, and the first physical unit may continue to be used.

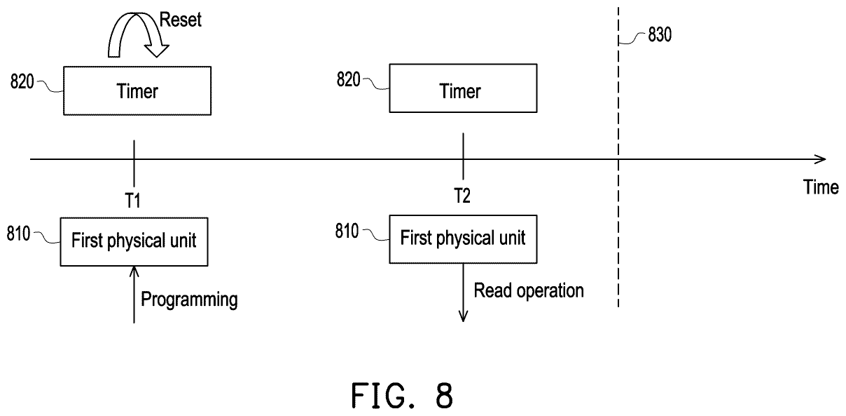

FIG. 8 is a schematic diagram of an operation of a timer according to a scenario. Referring to FIG. 8, the horizontal axis is time. At a time point T1, when a first physical unit 810 is programmed, a timer 820 corresponding to the first physical unit 810 is reset. For example, the timestamp is set to the current time, or the counter value is reset to 0. At a time point T2, the first physical unit 810 is subjected to the read operation and the data error condition is satisfied. A dotted line 830 represents the above threshold time, so the elapsed time (T2−T1) indicated by the timer 820 is less than the threshold time. In such an example, the first physical unit 810 meets the data error condition shortly after being programmed, so the first physical unit 810 is marked as a bad physical unit.

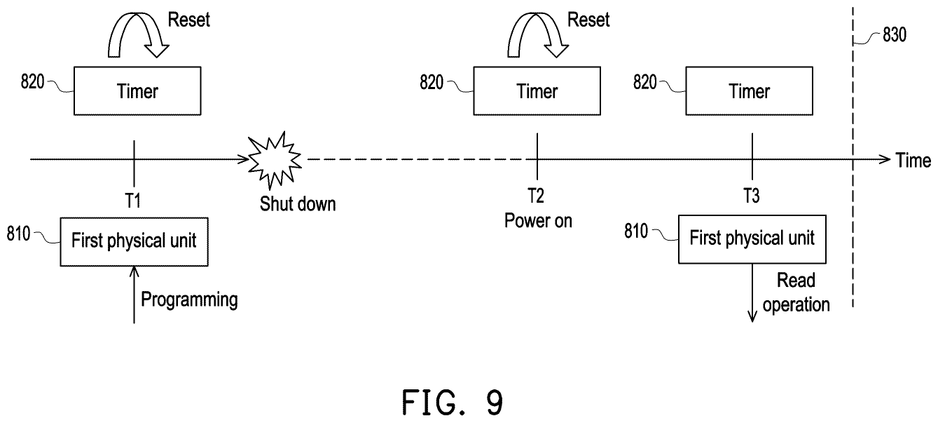

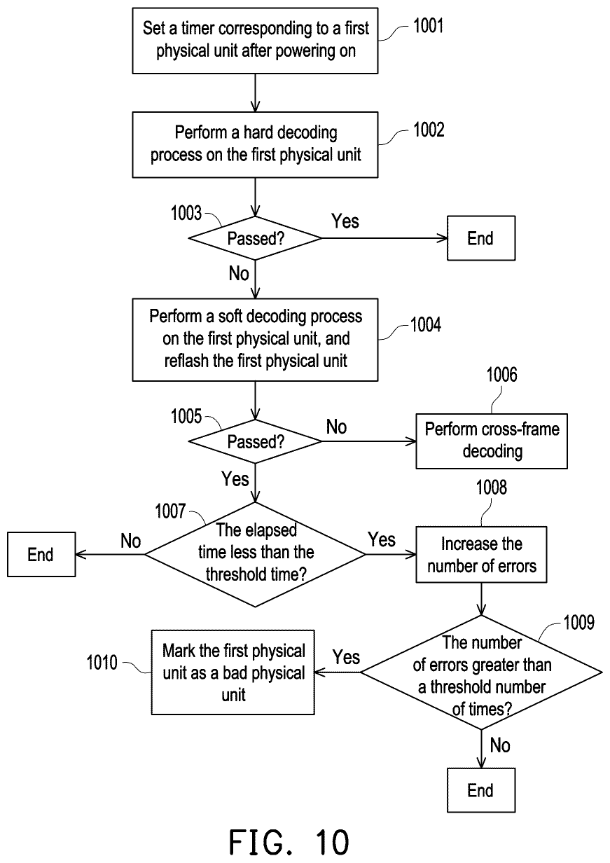

FIG. 9 is a schematic diagram of an operation of a timer according to another scenario. Referring to FIG. 9, at a time point T1, when the first physical unit 810 is programmed, the timer 820 corresponding to the first physical unit 810 is reset. However, when the memory storage device 10 is shut down, the timer 820 is not continuously updated, and the system clock also stops. At a time point T2, the computer is powered on. At this time, the timer 820 may no longer represent how much time has passed since the first physical unit 810 was programmed. Therefore, in an embodiment, the timer 820 is also reset when the computer is powered on. At a time point T3, the first physical unit 810 is subjected to the read operation and the data error condition is satisfied. Similarly, the dotted line 830 represents the threshold time. In this example, the elapsed time (T3−T2) indicated by the timer 820 is less than the threshold time, so the first physical unit 810 is also marked as a bad physical unit.

FIG. 10 is a flowchart of a memory management method according to an embodiment. Referring to FIG. 10, in step 1001, the timer is set after powering on. In step 1002, a hard decoding process is performed on the first physical unit. In step 1003, it is determined whether the hard decoding process is passed. If so, the process ends. If the hard decoding process fails, a soft decoding process is performed on the first physical unit in step 1004, and the first physical unit is reflashed. In step 1005, it is determined whether the soft decoding process is passed. When the soft decoding process fails, cross-frame decoding is performed in step 1006. For example, the hard decoding process and the soft decoding process use a single frame decoding, which means that the data bits used for decoding come from the same frame. However, the data bits used in cross-frame decoding come from a plurality of different frames. In some embodiments, the data bits required for single frame decoding are stored in the same physical unit, the data bits required for cross-frame decoding are stored in a plurality of physical units. The physical units may be distributed in the same (or different) memory plane, the same (or different) memory die, and/or the same (or different) chip enabled (CE) area. If the soft decoding process is passed, it is determined in step 1007 whether the elapsed time indicated by the timer is less than the threshold time. If the result of step 1007 is no, the process ends. If the result of step 1007 is yes, in step 1008, the number of errors is increased (for example, by 1). In step 1009, it is determined whether the number of errors is greater than a threshold number of times. If the result of step 1009 is yes, then in step 1010 the first physical unit is marked as a bad physical unit. If the result of step 1009 is no, the process ends. In the example of FIG. 10, the data error conditions include failure of the hard decoding process, passing the soft decoding process, and the number of errors being greater than the threshold number of times.

In the modified embodiment of FIG. 10, step 1007 may also be performed after step 1006 is performed. Therefore, when the soft decoding process fails, the first physical unit may be marked as a bad physical unit. In such a modified embodiment, the data error condition includes a hard decoding process failure and the number of errors being greater than a threshold number of times.

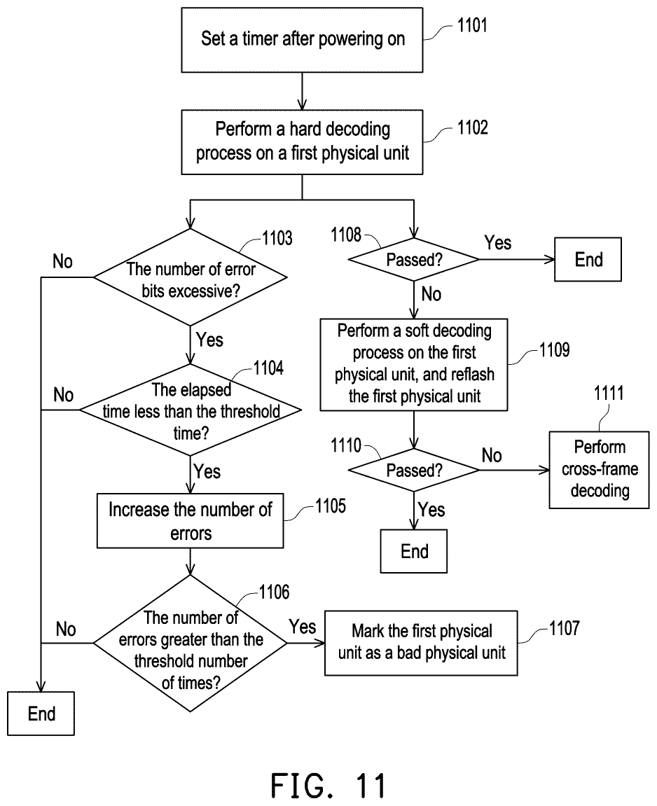

FIG. 11 is a flowchart of a memory management method according to another embodiment. Referring to FIG. 11, in step 1101, a timer is set after powering on. In step 1102, a hard decoding process is performed on the first physical unit. Next, steps 1103 and 1108 are performed in parallel. The hard decoding process may detect how many error bits there are and correct them if the number of error bits is less than or equal to the correction upper limit of the error correcting code. If the number of error bits is greater than the correction upper limit of the error correcting code, for example, if the verification fails in LDPC, the error bits may not be corrected. In step 1103, it is determined whether the number of error bits is excessive (greater than a threshold number). The threshold number may be greater than, equal to, or less than the correction upper limit of the error correcting code. If the result of step 1103 is yes, it is determined in step 1104 whether the elapsed time indicated by the timer is less than the threshold time. If the result of step 1104 is yes, in step 1105 the number of errors is increased. Next, in step 1106, it is determined whether the number of errors is greater than the threshold number of times. If the result of step 1106 is yes, then in step 1107 the first physical unit is marked as a bad physical unit. On the other hand, in step 1108, it is determined whether the hard decoding process is passed. If it fails, the process proceeds to step 1109 to perform the soft decoding process. In step 1110, it is determined whether the soft decoding process is passed. If not, cross-frame decoding is performed in step 1111. In the embodiment of FIG. 11, the data error condition includes that the number of error bits is greater than the threshold number and the number of errors is greater than the threshold number of times.

In some embodiments, the threshold number of times used in step 1009 and step 1106 is greater than or equal to 2 to avoid mistakenly marking available physical units as bad physical units. Referring to FIG. 9, since the timer 820 is reset when powering on, if the hard decoding process fails within the threshold time, the physical unit is marked as a bad physical unit. Consequently, the physical unit with endurance failure is marked as a bad physical unit, but such a physical unit may continue to be used as long as they are reflashed. Therefore, the threshold number of times is set to greater than or equal to 2. Even if the hard decoding process fails due to endurance failure, there is still an additional opportunity to continue using it. Through the above means, the situation of incorrect marking may be reduced.

In some embodiments, the number of errors used in step 1009 and step 1106 is also reset (for example, set to 0) when the computer is powered on (time point T2 in FIG. 9), and the number of errors are recalculated after the computer is restarted.

Referring to FIG. 7, in some embodiments, step 703 of determining whether the data error condition is met is based on non-RAID ECC parity information. In the embodiment, the above non-RAID ECC parity information includes information such as the hard decoding process, the number of error bits, the number of errors, the time elapsed after being programmed, or the time elapsed after powering on.

Through the above technical means, defective physical units during production may be detected and marked as bad physical units in real time, preventing the continuous reflash of the physical units from affecting system performance. The above approach may also avoid marking physical units with endurance defects as bad physical units, thus extending the service life of the memory.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. A memory management method for a rewritable non-volatile memory module, wherein the rewritable non-volatile memory module comprises a plurality of physical units, and the memory management method comprises:
setting a timer after powering on, wherein the timer corresponds to a first physical unit among the physical units;
performing a read operation on the first physical unit and determining whether a data error condition is met; and
marking the first physical unit as a bad physical unit when the data error condition is met and an elapsed time indicated by the timer is less than a threshold time.

2. The memory management method according to claim 1, further comprising:
resetting the timer when powering on.

3. The memory management method according to claim 1, further comprising:
resetting the timer when the first physical unit is programmed.

4. The memory management method according to claim 1, wherein the read operation comprises a hard decoding process, the hard decoding process is configured to detect a plurality of error bits in the first physical unit, and the step of determining whether the data error condition is met comprises:
adding the number of errors if the number of the error bits is greater than a threshold number; and
determining that the data error condition is met if the number of the errors is greater than a threshold number of times.

5. The memory management method according to claim 1, wherein the read operation comprises a hard decoding process, and the step of determining whether the data error condition is met comprises:
performing a soft decoding process and adding the number of errors when the hard decoding process fails; and
determining that the data error condition is met if the number of the errors is greater than a threshold number of times.

6. The memory management method according to claim 5, wherein the threshold number of times is greater than or equal to 2, and the memory management method also comprises:
resetting the number of the errors when powering on.

7. The memory management method according to claim 1, wherein the read operation comprises a hard decoding process, and the memory management method comprises:
performing a soft decoding process when the hard decoding process fails; and
performing a cross-frame decoding when the soft decoding process fails,
wherein the step of determining whether the data error condition is met is based on non-RAID ECC parity information.

8. A memory storage device, comprising:
a connection interface unit, configured to be coupled to a host system;
a rewritable non-volatile memory module, wherein the rewritable non-volatile memory module comprises a plurality of physical units; and
a memory control circuit unit, coupled to the connection interface unit and the rewritable non-volatile memory module,
wherein the memory control circuit unit is configured to perform a plurality of steps:
setting a timer after powering on, wherein the timer corresponds to a first physical unit among the physical units;
performing a read operation on the first physical unit and determining whether a data error condition is met; and
marking the first physical unit as a bad physical unit when the data error condition is met and an elapsed time indicated by the timer is less than a threshold time.

9. The memory storage device according to claim 8, wherein the steps further comprise:
resetting the timer when powering on.

10. The memory storage device according to claim 8, wherein the steps further comprise:
resetting the timer when the first physical unit is programmed.

11. The memory storage device according to claim 8, wherein the read operation comprises a hard decoding process, the hard decoding process is configured to detect a plurality of error bits in the first physical unit, and the step of determining whether the data error condition is met comprises:
adding the number of errors if the number of the error bits is greater than a threshold number; and
determining that the data error condition is met if the number of the errors is greater than a threshold number of times.

12. The memory storage device according to claim 8, wherein the read operation comprises a hard decoding process, and the step of determining whether the data error condition is met comprises:
performing a soft decoding process and adding the number of errors when the hard decoding process fails; and
determining that the data error condition is met if the number of the errors is greater than a threshold number of times.

13. The memory storage device according to claim 12, wherein the threshold number of times is greater than or equal to 2, and the steps further comprise:
resetting the number of the errors when powering on.

14. The memory storage device according to claim 8, wherein the step of determining whether the data error condition is met is based on non-RAID ECC parity information.

15. A memory control circuit unit configured to control a rewritable non-volatile memory module, wherein the rewritable non-volatile memory module comprises a plurality of physical units, and the memory control circuit unit comprises:
a host interface, configured to be coupled to a host system;
a memory interface, configured to be coupled to the rewritable non-volatile memory module;
a memory management circuit, coupled to the host interface and the memory interface,
wherein the memory management circuit is configured to perform a plurality of steps:
setting a timer after powering on, wherein the timer corresponds to a first physical unit among the physical units;
performing a read operation on the first physical unit and determining whether a data error condition is met; and
marking the first physical unit as a bad physical unit when the data error condition is met and an elapsed time indicated by the timer is less than a threshold time.

16. The memory control circuit unit according to claim 15, wherein the steps further comprise:
resetting the timer when powering on.

17. The memory control circuit unit according to claim 15, wherein the steps further comprise:
resetting the timer when the first physical unit is programmed.

18. The memory control circuit unit according to claim 15, wherein the read operation comprises a hard decoding process, the hard decoding process is configured to detect a plurality of error bits in the first physical unit, and the step of determining whether the data error condition is met comprises:
adding the number of errors if the number of the error bits is greater than a threshold number; and
determining that the data error condition is met if the number of the errors is greater than a threshold number of times.

19. The memory control circuit unit according to claim 15, wherein the read operation comprises a hard decoding process, and the step of determining whether the data error condition is met comprises:
performing a soft decoding process and adding the number of errors when the hard decoding process fails; and
determining that the data error condition is met if the number of the errors is greater than a threshold number of times.

20. The memory control circuit unit according to claim 19, wherein the threshold number of times is greater than or equal to 2, and the steps further comprise:
resetting the number of the errors when powering on.

21. The memory control circuit unit according to claim 15, wherein the step of determining whether the data error condition is met is based on non-RAID ECC parity information.
